(19) United States
(12) Patent Application Publication
(10) Pub. No.: US 2009/0106272 A1
(43) Pub. Date: Apr. 23, 2009

(54) Methods and tools for evaluating a mixture of turfgrass seeds

(75) Inventors: Bruce A. Jump, Grabill, IN (US); Leah Brilman, Corvallis, OR (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: Land O'Lakes, Inc., Arden Hills, MN (US)

(21) Appl. No.: 11/876,022

(22) Filed: Oct. 22, 2007

(51) Int. Cl. G06F 7/00

(52) U.S. Cl. 707/100

(57) ABSTRACT

One embodiment of a method for evaluating a mixture of turfgrass seed includes storing turfgrass seed information in a database (e.g., a computer readable storage medium). A user provides computer input indicative of a mixture of turfgrass seeds Information related to the indicated mixture is retrieved from the database. Based at least in part on the retrieved data, a user interface is created and presented to the user. In one embodiment, the user interface is a graph format display that enables the user to directly compare characteristics of the indicated mixture with characteristics of one or more different mixtures.

### BACKGROUND

There are many species of turfgrass seeds. Each species produces a grass that has unique characteristics. For example, species can produce grasses that vary in color, leaf width, moisture requirements, and density (i.e. number of living plants in a specified area).

Sometimes instead of using only one species of turfgrass seed, it is preferable to use a mixture of different species of turfgrass seeds. For example, it may be desirable to have a lawn of turfgrass that has dark green color and a high density. There may not be one species of seed that produces grass having these qualities. It may however be possible to create a mixture of different turfgrass seed species that would produce a mixture of grasses that collectively has the desired characteristics. For example, it may be possible to mix a seed species that produces grass with a dark green color with a species that produces grass with a high density.

It may also be desirable to mix species of seeds for economic reasons. For example, an optimal species for a particular setting may be prohibitively expensive. However, it may be possible to mix the expensive species with a more reasonably priced species to reduce cost while maintaining desired features.

Despite the benefits of using seed mixtures, it can be very difficult to choose a seed mixture. For example, a person may be interested in using a seed mixture that includes ten species. The person may be interested in ten characteristics of the grass the mixture produces. If the mixture contained equal amounts of each species, this would result in the person having to examine one hundred data points (i.e. each of the ten characteristics for each of the ten species). If the mixture contains unequal amounts of each species, the analysis becomes even more complicated. It can also be difficult to compare one seed mixture to another. It can also be difficult to determine and compare the costs associated with different mixtures.

### SUMMARY

One embodiment of a method of this invention includes storing turfgrass seed information in a database such as a computer readable storage medium. A user provides computer input indicative of a mixture of turfgrass seeds. Information related to the indicated mixture is retrieved from the database. Based at least in part on the retrieved data, a user interface is created and presented to the user. In one embodiment, the user interface is a graph format display that enables the user to directly compare characteristics of the indicated mixture with characteristics of one or more different mixtures.

### BRIEF DESCRIPTION OF THE DRAWINGS

FIG. 1 is a block representation of an exemplary computing environment.

FIG. 2 is a schematic diagram of a system for evaluating mixtures of turfgrass seeds.

FIG. 3 is a flow chart illustrating steps associated with evaluating mixtures of turfgrass seeds.

FIG. 4 is an illustration of a spreadsheet program worksheet.

FIG. 5 is a flow chart demonstrating steps associated with using a spreadsheet workbook to evaluate a mixture or mixtures of turfgrass seeds.

FIG. 6 is an illustration of a user interface for storing turfgrass seed characteristic information.

FIG. 7 is an illustration of a user interface for storing turfgrass seed economic information.

FIG. 8 is an illustration of a user interface for storing seed mixture information.

FIG. 9 is an illustration of a user interface for identifying a turfgrass seed mixture.

FIG. 10 is an illustration of a user interface for managing the retrieval, calculation, and display of turfgrass seed mixture characteristics.

FIG. 11 is an illustration of a mixture evaluation chart.

FIG. 12 is an illustration of a mixture evaluation table.

### DETAILED DESCRIPTION

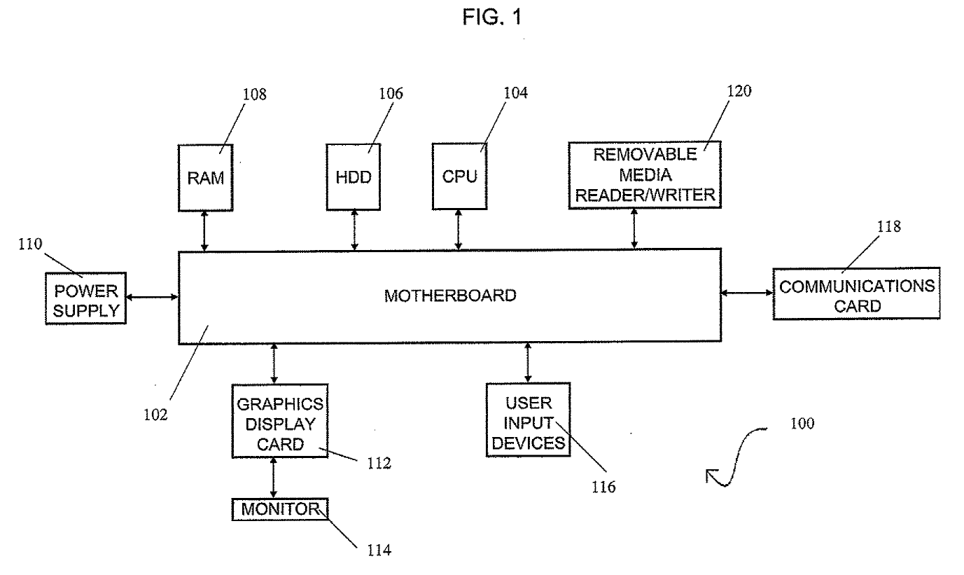

Certain embodiments described herein are intended for implementation in association with a computing device such as, but not limited to, a personal computer, a laptop computer, or a personal digital assistant. A Computing device generally illustrated at 100 in FIG. 1 is just one example of a suitable device and is not intended to suggest any limitation as to the scope of use or functionality of the claimed subject matter. Neither should computing device 100 be interpreted as having any dependency or requirement relating to any one or combination of illustrated components.

Computing device 100 includes a motherboard 102, a central processing unit 104, a hard disk drive 106, random access memory 108, a power supply 110, a graphics display card 112, a monitor 114, user input devices 116, a communications card 118, and removable media reader/writer 120. Hard disk drive 106 is configured to write information to, and read information from computer readable storage media. Random access memory 108 is also configured to write information to, and read information from computer readable storage media. Removable media reader/writer 120 is configured to write information to, and read information from removable media such as, but not limited to, a magnetic disk, an optical disk, and/or flash memory. User input devices 116 are configured to receive various inputs from a user. Devices 116 can include, but are not limited to, a keyboard, a mouse, a touch screen, and/or a microphone. Communications card 118 enables computing device 100 to transfer data to and from other electronic devices.

Graphics display card 112 generates graphical image information and outputs the information such that it can be viewed on a monitor. Monitor 114 receives a signal from graphics display card 112 and displays visual images on its screen for a user to view. Central processing unit 104 executes computer program instructions and processes data. Motherboard 102 provides electrical and logical connections by which the other components of the system communicate. For example, motherboard 102 allows the central processing unit 104 to read data from, and write data to random access memory 108. Finally, power supply 110 provides for the electrical requirements of computing device 100. For example, electricity needed to operate hard disk drive 106 and monitor 114 illustratively originates from power supply 110.

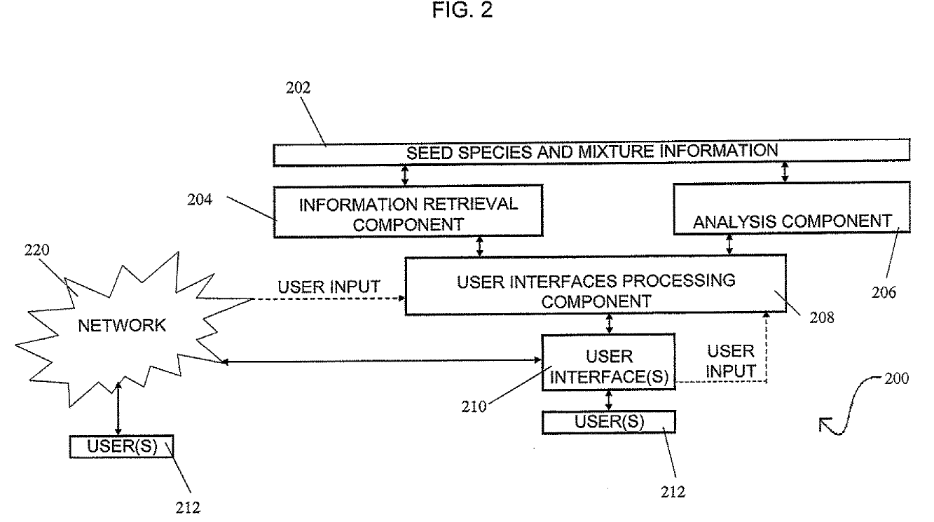

A system 200 illustrated in FIG. 2 is used to evaluate a mixture or mixtures of turfgrass seeds. System 200 is illustratively implemented in the context of a computing system such as but not limited to computing device 100 as illustrated in FIG. 1. System 200 includes a database 202 containing seed species and mixture information, an information retrieval component 204 configured to facilitate retrievals of information from database 202, analysis component 206 configured to perform computations relative to information contained in database 202, and a user interface processing component 208 configured to generate one or more user interfaces 210 so as to present information derived by component 204 and/or 206. Component 208 also optionally includes a network interface that enables data transfer with a network.

One or more users 212 illustratively interact within system 200 by providing input for example providing commands to component 208 in order to manipulate interfaces 210. In one embodiment, a user 212 interacts directly with a computing device upon which one or more of the other components of system 200 are installed. However, in another embodiment, a user 212 interacts remotely through a network 220 such as but not limited to the Internet.

Information in database 202 can be acquired from a variety of sources such as, but are not limited to, websites, product brochures, and published reports. The information can include anything that may be useful for purposes such as, but not limited to, identifying, comparing, or evaluating a mixture of turfgrass seeds. The information can include, but is certainly not limited to, price information, quality information, and/or types and amounts of species of seeds within a given mixture.

A user 212 is illustratively a person that uses system 200 to evaluate a mixture. In the context of computing device 100 described in relation to FIG. 1, a user 212 illustratively provides input by way of devices 116 and reviews interfaces 212 by way of monitor 114. Information retrieval component 204, analysis component 206 and user interface processing component 208 are illustratively stored on a computer readable storage medium for example stored within RAM 108 or hard disk drive 106 and retrieved and executed by central processing unit 104. Database 202 is illustratively stored and maintained on a computer readable storage medium such as, but not limited to, hard disk drive 106 or random access memory 108.

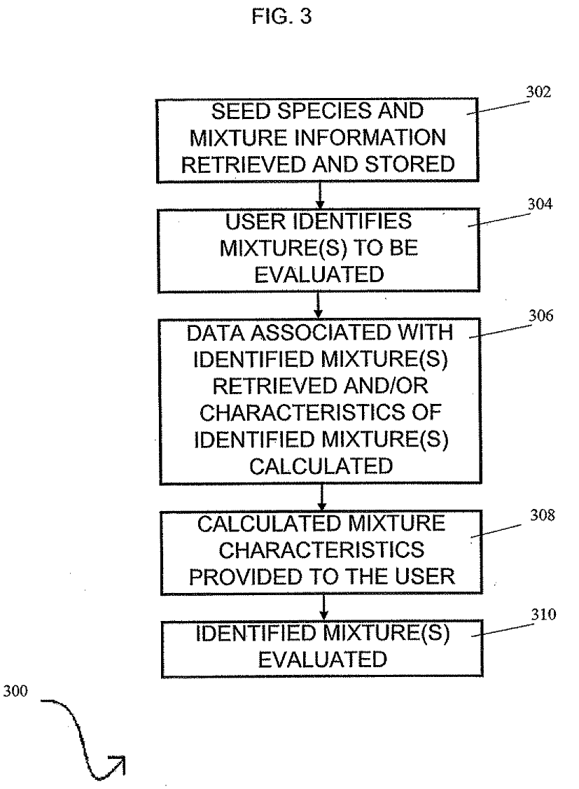

A method 300 as illustrated in FIG. 3 is used to evaluate a mixture or mixtures of turfgrass seeds. The method 300 can be carried out within a system the same or similar to the system 200 of FIG. 2. Thus, for the purpose of illustration, the steps of method 300 will be described in the context of system 200. In accordance with block 302, seed species and mixture information is obtained and stored in database 202. This may involve, but is not limited to, a user such as user 212 manually retrieving and storing information, or a programmed computing device automatically retrieving and storing information.

In accordance with block 304, user(s) 214 provides input and in doing so identifies a mixture or mixtures of turfgrass seeds to be evaluated. Mixtures can be identified by any of a variety of methods such as, but not limited to, a user selecting a mixture from a list of mixtures, or a user identifying a custom mixture by utilizing a keyboard or other input device to enter types and quantities of species within a mixture.

In accordance with block 306, information retrieval component 204 retrieves information from database 202 that is associated with the mixture or mixtures identified in block 304. In addition, analysis component 206 may be utilized to derive additional information by performing a related calculation. For example, component 206 is illustratively configured to calculate a characteristic that is not otherwise stored in database 202 as raw data. In one embodiment, a calculated characteristic is stored in database 202 such that it can be retrieved rather than re-calculated when responding to subsequent same or similar user requests.

Mixture characteristics that are retrieved or computed can include, but are not limited to, quality and outcome characteristics of the grass produced by the identified mixture(s) and/or cost considerations. In one embodiment, the characteristics are determined using the information about the mixture(s) itself and/or information about the individual species within the mixture(s). For example, if a hypothetical “Mixture 1” is selected and it consists of 50% of “Type A” seed and 50% of “Type B” seed, and if “Type A” seed cost $100 per a pound and “Type B” seed cost $50 per a pound, then analysis component 208 is illustratively configured to calculate the cost of “Mixture 1” at $75 per a pound.

In accordance with block 308, information retrieved and/or identified at block 306 is provided to user 212. In one embodiment, this means providing the information through user interfaces 210. Interfaces 210 can include, but are not limited to, tabular or graphical representations of the information on a computer monitor.

In accordance with block 310, the mixture or mixtures identified by the user are evaluated using the information provided in accordance with block 308. Methods of evaluating include, but are not limited to, a person comparing quality characteristics and/or economic considerations related to grasses produced by the mixtures. In an embodiment, a user evaluates a mixture by comparing characteristics of a mixture to his or her requirements such as color, density, cost or other requirements.

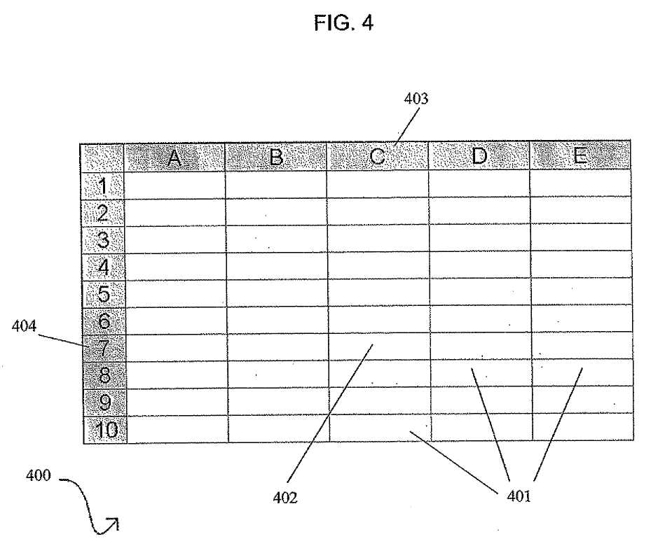

In one embodiment, at least one interface 210 through which mixture-related information is provided to user(s) 212 is a worksheet that is an implementation of a spreadsheet application. A spreadsheet worksheet is generally indicated at 400 in FIG. 4. Worksheet 400 includes cells 401, an illustrative 3 are identified in FIG. 4. As will be familiar to those skilled in the art, each cell is assigned a unique identifying address defined by the column letter and row number. For example, cell 402 is in the “C” column as indicated by the column identifier 403 and is in row “7” as indicated by the row identifier 404. Cells 401 are illustratively equipped with standard spreadsheet functionality known in the art such as, but not limited to, the capacity to retrieve information from other cells and apply mathematical formulas. Those skilled in the art will appreciate that groups of worksheets can illustratively be contained in a workbook. Within a workbook, the cells of all of the worksheets can be configured to function together as if they were in a single worksheet. For example, a first worksheet can be equipped with a formula that instructs the spreadsheet program to retrieve a numerical value stored in a specified cell in a second worksheet, to perform a specified function (e.g., multiply by one hundred), and then to store the resulting value in a particular cell associated with a particular worksheet.

Those skilled in the art will appreciate that a spreadsheet application also often includes more advanced features. One advanced feature is support for creating a graphical representation of data contained in a workbook. Another advanced feature is a capacity to interpret scripting programming languages. For example, a scripting programming language could be used to perform a function such as “hiding” specified cells in a worksheet.

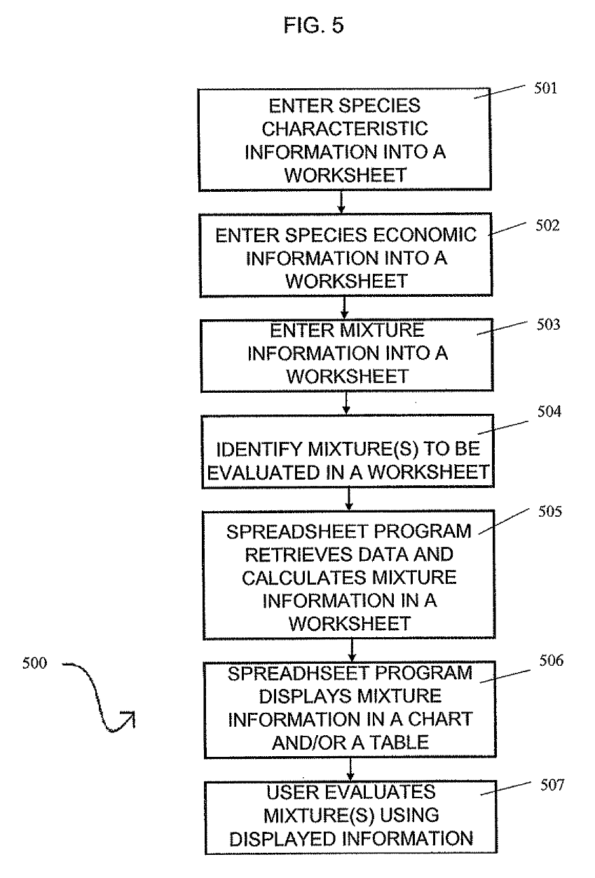

FIG. 5 is a flow chart illustrating an embodiment. A method generally indicated at 500 for using a spreadsheet workbook as a user interface 210 to evaluate a mixture or mixtures of turfgrass seeds. The workbook is illustratively stored to a computer readable medium as executable instructions for a computing device. In method 500, several workbook spreadsheets, tables, and graphs are used in combination. For example, some spreadsheets store information, some spreadsheets retrieve information from other spreadsheets, some spreadsheets are used to make calculations, some spreadsheets are configured to accept user input, and some spreadsheets are configured to generate graphs and charts.

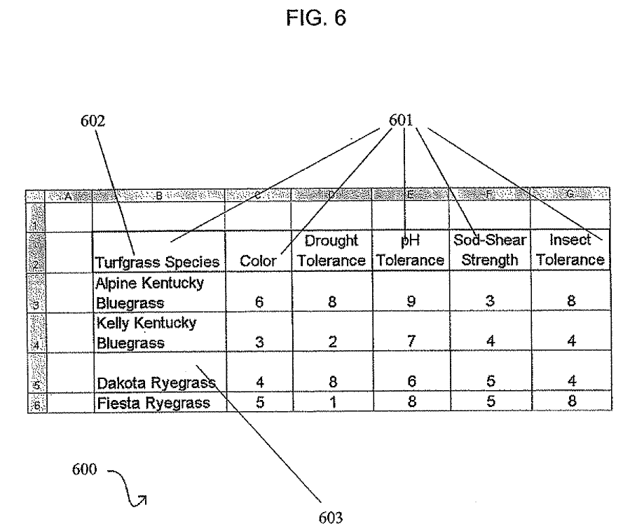

In accordance with block 501, a user enters turfgrass seed species characteristic information into a worksheet. An example of an interface 210 for entering and storing turfgrass seed species information is illustrated in a worksheet generally indicated at 600 in FIG. 6. The second to the top row of worksheet 600 (row “2”), contains labels 601 that describe the nature of data contained in the corresponding columns. For example, label 602 reads “Turfgrass Species.” This indicates that the information listed in that column are identifiers of different species of turfgrass seeds. For each species of turfgrass seed, corresponding characteristics are listed in the columns of the corresponding row. For example, row “5”, includes the identifying information “Dakota Ryegrass” 603 in the “Turfgrass Species” column. This indicates that the information in row “5” is related to a species of turfgrass named “Dakota Ryegrass.”

In one embodiment, the characteristic information included in worksheet 600 for each species includes some or all of the species characteristic information reported by the National Turf Evaluation Program of Beltsville, Md. (hereinafter “NTEP”). In one embodiment, the characteristics included in worksheet 600 for each species include some or all of aggressiveness, brown patch, certified genetics, cold tolerance, color, compaction tolerance, dollar spot, drought tolerance, early spring green up, endophyte/insect resistance, fast establishment, height/moving frequency, high pH tolerance, insect tolerance, leaf spot, leaf texture, low maintenance, low mowing height, mountain west quality, mowing quality, necrotic ring spot, PNW quality, quality ratings, red thread, phizomatous, rust, salt tolerance, shade tolerance, shade/powdery mildew, sod-shear strength, summer patch, summer stress, wear tolerance, and winter active growth.

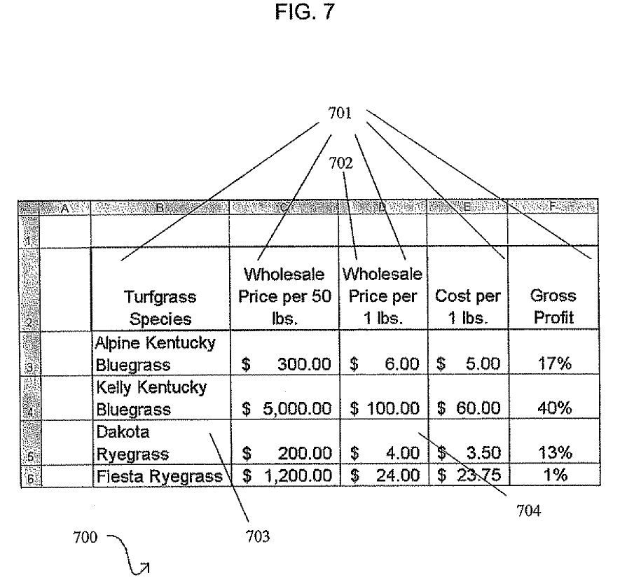

In accordance with block 502, a user enters turfgrass seed species economic information into a worksheet. An example of an interface 210 for entering and storing species economic information is illustrated in a worksheet generally indicated at 700 in FIG. 7. In one embodiment, the economic information included in worksheet 700 for each species includes some or all of pnce, cost, and profit margin information. The second to the top row of worksheet 700 (row “2”), contains labels 701 that describe the nature of data contained in the corresponding rows. For example, label 702 reads “Wholesale Price per 1 lbs.” This indicates that the information in the corresponding column is wholesale price information for one pound of turfgrass seed. For each species of turfgrass seed, corresponding characteristics are listed in the columns of the corresponding row, For example, cell 703 includes the identifying information “Dakota Ryegrass” and cell 704 includes the information “$4.00.” This indicates that the Dakota Ryegrass species of turfgrass has a wholesale price of $4.00 per a pound.

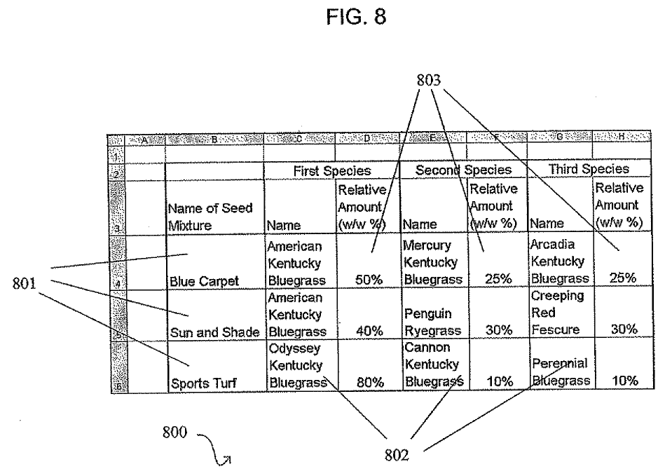

In accordance with block 503, a user enters grass seed mixture information into a worksheet. An interface 210 for entering and storing grass seed mixture information into a worksheet is generally indicated at 800 in FIG. 8. Mixture information includes, but is not limited to, composition information such as type and amount of each species in a mixture. The second column of worksheet 800, column “B”, contains information 801 that identifies a turfgrass seed mixture. Columns 802 identify the name of each species of turfgrass seed in the mixture, and columns 803 identify the relative amounts of each species in the mixture. For example, row “6” in worksheet 800 indicates that the “Sports Turf” mixture includes eighty percent by weight of the “Odyssey Kentucky Bluegrass” species, ten percent by weight of the “Cannon Kentucky Bluegrass” species, and ten percent by weight of the “Perennial Bluegrass” species. The relative amounts of each species in the mixture can be expressed in various manners such as, but not limited to, in terms of ratios such as a ratio of the weight of the species to the total weight of all the species in the mixture, or a ratio of the number of seeds of the species to the total number of seeds in the mixture.

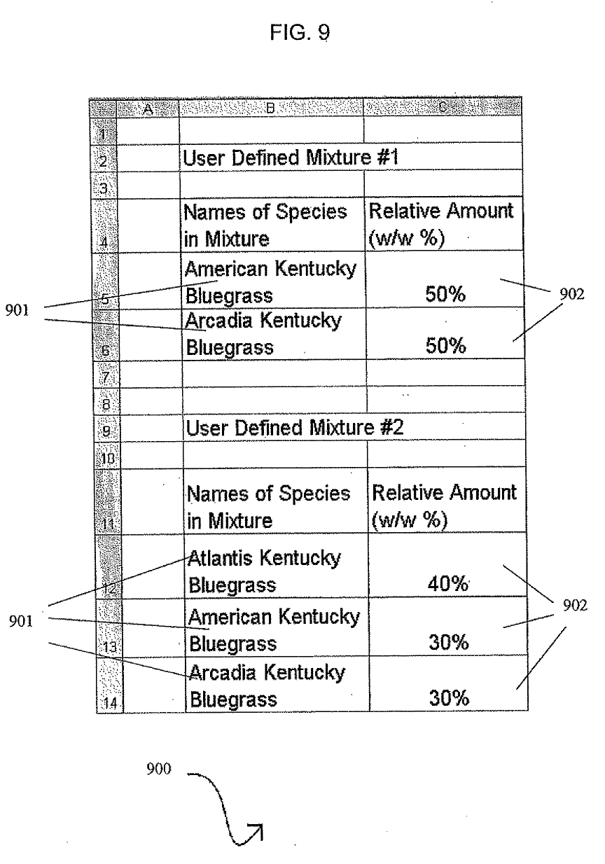

In accordance with block 504, a user identifies, in a worksheet, the grass mixture or mixtures to be evaluated. An example of an interface 210 for identifying grass seed mixtures is illustrated in a worksheet generally indicated at 900 in FIG. 9. A user identifies the species of each seed in the mixture in cells 901 and enters the relative amount (e.g. W/w ratio or percentage) of each seed in the mixture in cells 902. For example, worksheet 900 indicates that the mixture labeled “User Defined Mixture #1” includes fifty percent by weight of the “American Kentucky Bluegrass” species and fifty percent by weight of the “Arcadia Kentucky Bluegrass” species.

In an embodiment, a user can identify a mixture of seeds to be evaluated by either entering mixture information such as shown in worksheet 900, or by choosing a mixture from a list. The list could contain, for example, the mixtures identified in worksheet 800.

In another embodiment, a user can identify a mixture from a list and that mixture information will be automatically entered into worksheet 900. For example, a user could select the mixture “Michigan Green Mixture” from a list of mixtures and its species and relative amount information would be automatically entered into worksheet 900. A user could then optionally make modifications to the mixture to create a new, but related mixture for evaluation.

In yet another embodiment, a user can first limit the selection of mixtures to be listed by first choosing a characteristic such as a sales region. The list of mixtures will then be limited to only those mixtures sold in that region. For example worksheet 800 could include information relating to whether or not a mixture is sold in Colorado. In an embodiment, a user could select to exclude mixtures not sold in Colorado from being displayed in the list. In an embodiment, the mixtures are excluded utilizing a scripting programming language interpreted by the spreadsheet application.

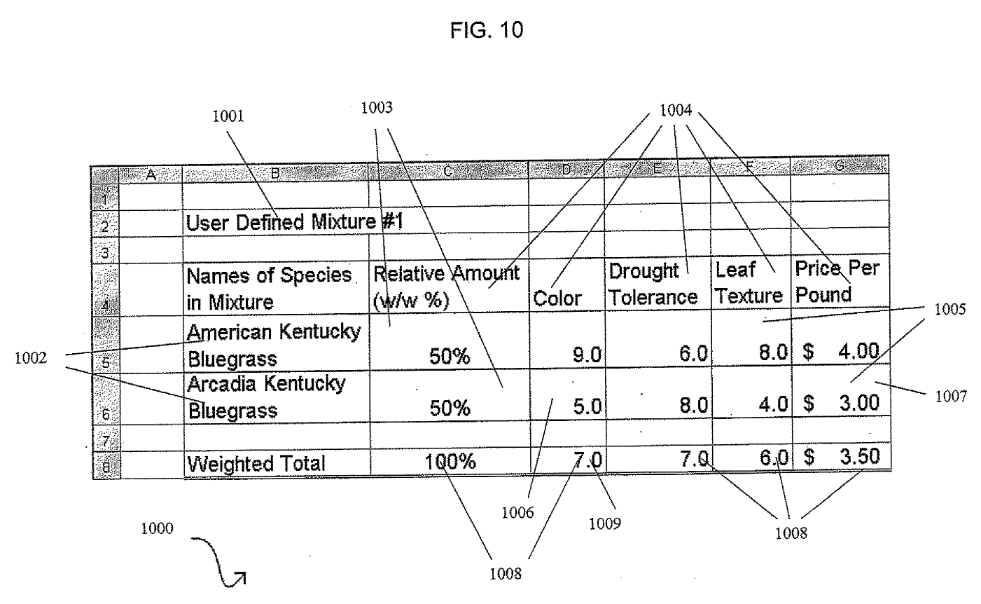

In accordance with block 505, a spreadsheet program retrieves data and calculates mixture information in a worksheet. An interface 210 for retrieving data and calculating mixture information is illustrated in a worksheet generally indicated at 1000 in FIG. 10. FIG. 10 illustratively retrieves data for the mixture or mixtures to be evaluated from worksheets such as worksheets 600, 700, 800, and 900, and then calculates cost and quality information for each mixture. In worksheet 1000′ cell 1001 indicates that the mixture is the “User Defined Mixture #1” mixture, cells 1002 indicate the species of seeds in the mixture, and cells 1003 indicate the percentages of each species of seed in the mixture. Cells 1004 include quality characteristic and price labels. Cells 1005 (an illustrative two are identified in FIG. 10) include formulas to retrieve the appropriate value. For example, cell 1006 includes a formula that retrieves the “Color” characteristic value for “Arcadia Kentucky Bluegrass” species from a worksheet such as worksheet 600. Also for example, cell 1007 includes a formula that retrieves the “Price Per Pound” value for “Arcadia Kentucky Bluegrass” species from a worksheet such as worksheet 700.

Characteristics such as quality and price characteristics for each mixture are calculated in cells 1008. Cells 1008 contain formulas that utilize spreadsheet application capabilities such as retrieving information (e.g. using information retrieval component 204) and performing mathematical calculations (e.g. using analysis component 206). In accordance with one embodiment, equation 1 below) is a mathematical expression for calculating a mixture characteristic value.

$${C}_{M} = {\sum }_{i = 1}^{n} {p}_{i} \cdot {C}_{i} \qquad Equation 1$$

A characteristic or attribute of a mixture, C_{M}, is determined by multiplying the characteristic for each species in the mixture, Cᵢ, by its relative amount in the mixture, pᵢ, and then totaling the values. For example, cell 1009 calculates the “Color” characteristic of the “User Defined Mixture #1” mixture to be “7.0” by multiplying the “American Kentucky Bluegrass” species color value “9.0” by its relative amount “50%”, and adding this to the product of the “Arcadia Kentucky Bluegrass” species color value of “5.0” and its relative amount “50%” (i.e. 9.0×50%+5.0×50%=7.0).

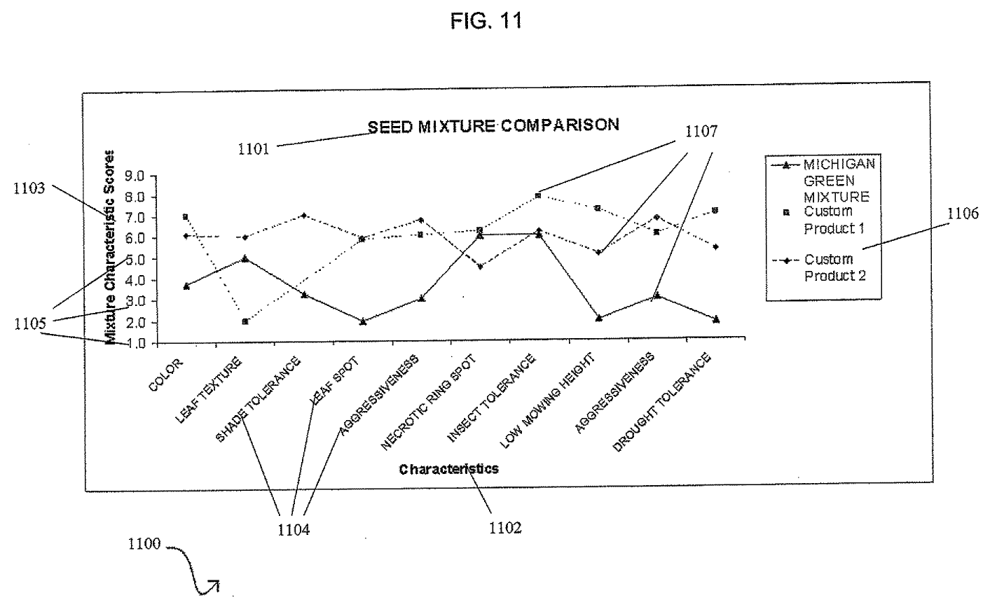

In accordance with block 506, a spreadsheet program displays mixture information in a chart and/or a table. An interface 210 for displaying mixture information is illustrated in a chart indicated at 1100 in FIG. 11. Chart 1100 is illustratively a chart generated by the spreadsheet application or associated functionality. Chart 1100 is configured such that it retrieves the quality characteristics from worksheet 1000 of each mixture to be evaluated and displays that information in graphical form. Chart 1100 includes a chart label 1101, an x-axis label 1102, a y-axis label 1103, quality characteristic qualitative labels 1104 (an illustrative 3 are identified in FIG. 11), quality characteristic quantitative labels 1105 (an illustrative 3 are identified in FIG. 11), a legend 1106, and quality characteristic value indicators 1107. In one embodiment, the mixtures identified in legend 1106 correspond to the mixtures identified to be evaluated in step 504, and the graphical representations 1107 for each mixture are different colors.

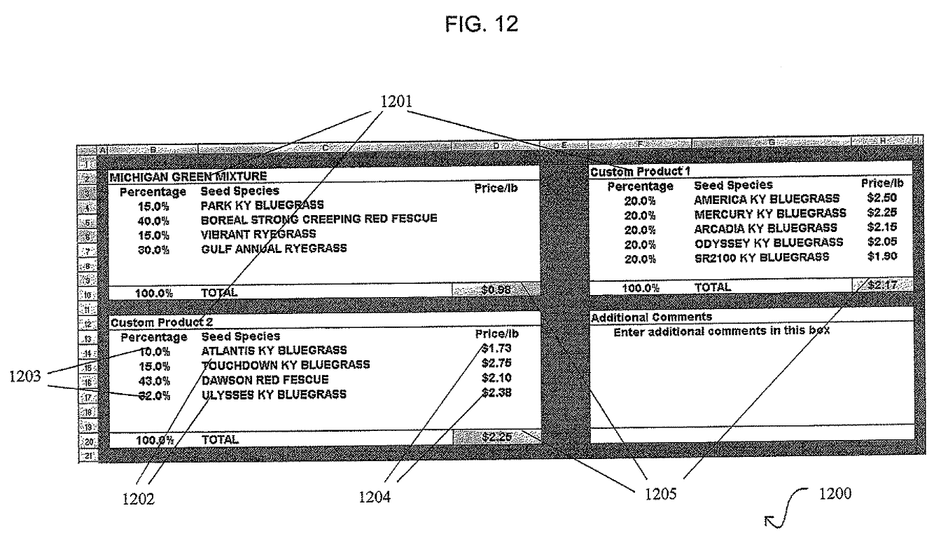

An example of an interface 210 for displaying mixture information is shown in a table generally indicated at 1200 in FIG. 12. Table 1200 is illustratively a table generated by the spreadsheet application or associated functionality. Table 1200 is configured such that it retrieves mixture characteristics from worksheet 1000 of each mixture identified to be evaluated and displays that information in tabular form. Table 1200 includes mixture labels 1201, species labels 1202 (an illustrative two are identified in FIG. 12), species relative amount information 1203 (an illustrative two are identified in FIG. 12), species price information 1204 (an illustrative two are identified in FIG. 12), and mixture price information 1205.

In accordance with block 507, a user evaluates a mixture using information displayed in chart 1100 and/or table 1200. In one embodiment, a user uses Chart 1100 and Table 1200 to evaluate a mixture based upon their needs. For example, Table 1200 shows that the “Michigan Green Mixture” price per pound is $0.98, that the “Custom Product 1” price per pound is $2.17, and that “Custom Product 2” price per pound is $2.25. A user may only have a budget for $2.10 per pound. Table 1200 shows that “Custom Product 1” and “Custom Product 2” are out of his or her budget. Additionally, Table 1200 shows the prices of the species of seeds in “Custom Product 1” and “Custom Product 2.” The user could use this information to modify the mixtures so that they meet his or her criteria. For example, Table 1200 shows that “Custom Product 1” includes the species “America KY Bluegrass” that has a price per pound of $2.50 and also includes the species “SR2100 KY Bluegrass” that has a price per pound of $1.90. A user could modify “Custom Product 1” by decreasing the amount of the more expensive species and increasing the amount of the less expensive species, such that the mixture price will meet the price requirements.

In another embodiment, a user evaluates a mixture or mixtures using Chart 1100. Chart 1100 is useful in evaluating a mixture because it allows a user to easily compare his or her needs to the characteristics of the mixture or mixtures, and also allows for a user to easily detect strengths and weaknesses between mixtures. For example, “Custom Product 1” as is indicated by legend 1106 is represented by the square value indicators. The “Color” value indicator shows that “Custom Product 1” has the highest score for this characteristic. If a user is only concerned with “Color”, this would indicate to the user that he or she should select “Custom Product 1.” Chart 1100 also shows that for the “Leaf Texture” characteristic, “Custom Product 1” has the lowest score. If a user was interested in a mixture with good performance in both “Color” and “Leaf Texture”, Chart 1100 shows that he or she may want to choose “Custom Product 2” represented by the diamond value indicators which has slightly lower “Color” performance than “Custom Product 1”, but has much better “Leaf Texture” performance.

In yet another embodiment, Chart 1100 and Table 1200 are used in combination. For example, Chart 1100 shows that the “Michigan Green” mixture has the lowest performance for nine out of the ten characteristics displayed. However, Table 1200 shows that the “Michigan Green” mixture cost less than half the price of the other mixtures. A user can compare his or her needs for price and performance, and make a decision. For example, even though “Michigan Green” mixture generally under performs the other two mixtures, it may be the preferable mixture considering cost requirements.

It is worth noting that the embodiments are only shown for illustrative purposes and not for limitation. For example, worksheet 600 in FIG. 6 only shows four species of seeds and four species characteristics. An embodiment can include any number of species and any number of characteristics. Also for example, worksheet 1000 in FIG. 10 only shows one user defined mixture including only two species of seeds. An embodiment of worksheet 1000 could of course include any number of user defined mixtures, and each mixture could include any number of species.

It is also worth noting that the user in FIG. 5 need not be the same user at every step. In an embodiment, a first user may enter the information in steps 501, 502, and 503, and a second user may identify the mixtures to be compared in step 504 and evaluate a mixture in step 507. In another embodiment, a different user performs each step. In yet another embodiment, steps may be automated such that a user is not required.

Finally, it is worth noting that the described methods and tools are only illustrative embodiments of methods and tools for evaluating a turfgrass seed mixture. They are not limitations. Methods and tools for evaluating a turfgrass seed mixture can use spreadsheets differing from what has been shown, the method and tool can include computer programs other than a spreadsheet program, and the method and tool need not include any computer programs, the method and tools can be done manually. Workers skilled in the art will recognize that changes may be made in form and detail without departing from the spirit and scope of the invention.

Although the present invention has been described with reference to preferred embodiments, workers skilled in the art will recognize that changes may be made in form and detail without departing from the spirit and scope of the invention.

What is claimed is:

1. A computer-implemented method, comprising:
receiving a first attribute, the first attribute being indicative of a characteristic of grass produced by a first grass seed species;
receiving a second attribute, the second attribute being indicative of the characteristic relative to grass produced by a second grass seed species;
receiving an indication of a grass seed mixture, the indication including information related to relative amounts of the first and second seed species in the grass seed mixture;
determining a third attribute, the third attribute being indicative of the characteristic relative to grass produced by the grass seed mixture; and
providing output indicative of the third attribute.

2. The method of claim 1, wherein determining comprises determining based at least in part on a relationship between the first and second attributes.

3. The method of claim 2, wherein the first and second attributes are numerical, and wherein determining based at least in part on a relationship comprises determining by computing an average.

4. The method of claim 1, wherein providing output comprises displaying output indicative of the third attribute on a monitor.

5. The method of claim 4, wherein displaying output comprises displaying output in a tabular format.

6. The method of claim 4, wherein displaying output comprises displaying output in a graphical format.

7. The method of claim 1, wherein receiving an indication of a grass seed mixture comprises receiving an indication from a user.

8. The method of claim 7, wherein receiving an indication from a user comprises receiving an indication of a grass seed mixture selected from a list of grass seed mixtures displayed on a monitor.

9. A system for providing grass seed information, the system comprising:
a database that contains a collection of attributes associated with first and second seed species;
an analysis component that calculates, based at least in part on the collection of attributes, a collection of the same attributes relative to a mixture that contains the first and second seed species; and
a user interface component that generates and provides a user interface that includes an indication of the collection of attributes calculated by the analysis component.

10. The system of claim 9 further comprising a network interface that enables remote interaction with the system.

11. The system of claim 9, wherein the collection of attributes associated with first and second seed species comprises attributes associated with the grass produced by the species.

12. The system of claim 9, wherein the collection of attributes associated with the first and second seed species comprises economic attributes.

13. The system of claim 12, wherein the economic attributes comprise price attributes.

14. The system of claim 9, wherein the database further comprises a collection of attributes associated with the mixture.

15. A user interface system for providing grass seed information, comprising:
a user interface component that facilitates a first user selection, the first user selection being indicative of a first mixture of grass seeds;
a second user interface component that facilitates a second user selection, the second user selection being indicative of a second mixture of grass seeds;
a user interface that displays, based at least in part on the first and second user selections, characteristics of the first mixture of grass seeds relative to characteristics of the second mixture of grass seeds.

16. The system of claim 15, wherein the characteristics of the first mixture are determined by applying a mathematical operation.

17. The system of claim 16, wherein the mathematical operation includes multiplying a characteristic value by a relative amount.

18. The system of claim 17, wherein the relative amount is a ratio.

19. The system of claim 18, wherein the ratio is a weight to weight ratio.

20. The system of claim 18, wherein the ratio is a ratio of the number of seeds of one species in the first mixture to the total number of the seeds in the first mixture.
